(19) United States
(12) Patent Application Publication
(10) Pub. No.: US 2026/0194738 A1
(43) Pub. Date: Jul. 9, 2026

(54) VISUAL SYSTEM

(71) Applicant: ZHEJIANG SUNNY OPTICS CO., LTD., Yuyao City (CN)

(72) Inventors: Huan LIU, Yuyao City (CN); Xiaobin ZHANG, Yuyao City (CN); Lin HUANG, Yuyao City (CN)

(73) Assignee: ZHEJIANG SUNNY OPTICS CO., LTD., Yuyao City (CN)

(21) Appl. No.: 19/420,028

(22) Filed: Dec. 15, 2025

(30) Foreign Application Priority Data
Jan. 6, 2025 (CN) 202510020170.4

(51) Int. Cl. G02B 17/08

(52) U.S. Cl. CPC G02B 17/0856

(57) ABSTRACT

A visual system includes, in order from a first side to a second side along an optical axis, a first lens, a reflective polarizing element, a quarter-wave plate, a second lens, a third lens and a partially reflective element, wherein the third lens is configured to be able to move along the optical axis to approach or move away from a display located on the second side, so that the visual system switches between a first state and a second state; an effective focal length f3 of the third lens and an effective focal length fm of the visual system in the first state satisfy 4.95≤f3/fm≤6.24; and a center thickness CT3 of the third lens on the optical axis and an amount of change Δf in the effective focal length of the visual system when switching from the first state to the second state satisfy 3.20≤CT3/Δf≤3.56.

### CROSS-REFERENCE TO RELATED APPLICATIONS

The present application claims the priority of Chinese patent application No. 202510020170.4, filed on Jan. 6, 2025, which is hereby incorporated by reference in its entirety.

### TECHNICAL FIELD

The present application relates to the field of optical elements, and more particularly, to a visual system.

### BACKGROUND

Virtual Reality (VR) technology can offer immersive experiences and allows for virtual reality training and so on. It has broad application prospects in many fields such as entertainment, education, healthcare and tourism, and its application is expected to continue to grow. Therefore, providing higher-performance, smaller-volume, and lighter VR visual systems has always been a goal pursued by those skilled in the art. In addition, some of current VR users need to wear glasses, but many VR devices are not compatible with glasses, thereby affecting the user experience. Therefore, it is necessary to develop and design a focus-adjustable VR device to satisfy the needs of users with different eyesight and provide a better user experience.

### SUMMARY

The present application provides a visual system that may comprise, in order from a first side to a second side along an optical axis: a first lens having a positive refractive power, with a first side surface being convex; a reflective polarizing element; a quarter-wave plate; a second lens having a positive refractive power or a negative refractive power, with a first side surface being planar; a third lens having a positive refractive power, with a first side surface being convex and a second side surface being convex; and a partially reflective element. The third lens is configured to be able to move along the optical axis to approach or move away from a display located on the second side, so that the visual system switches between a first state and a second state. The visual system may satisfy conditional expressions of 4.95≤f3/fm≤6.24 and 3.20≤CT3/Δf≤3.56, where f3 is an effective focal length of the third lens, fm is an effective focal length of the visual system in the first state, CT3 is a center thickness of the third lens on the optical axis, and Δf is an amount of change in the effective focal length of the visual system when switching from the first state to the second state.

In an implementation, a radius of curvature R1 of the first side surface of the first lens, the effective focal length fm of the visual system in the first state, and the effective focal length fn of the visual system in the second state may satisfy: 1.45<R1/(fm+fn)<1.95.

In an implementation, a center thickness CT1 of the first lens on the optical axis, a center thickness CT2 of the second lens on the optical axis, and a distance ΔL by which the third lens moves along the optical axis in a process of the visual system switching from the first state to the second state may satisfy: 2.74≤(CT1+CT2)/ΔL≤4.30.

In an implementation, an effective focal length f1 of the first lens and a distance TDm on the optical axis from the first side surface of the first lens to the second side surface of the third lens in the first state of the visual system may satisfy: 4.25<f1/TDm<8.1.

In an implementation, a distance T23m on the optical axis from the second side surface of the second lens to the first side surface of the third lens in the first state of the visual system, and a distance T23n on the optical axis from the second side surface of the second lens to the first side surface of the third lens in the second state of the visual system, and a distance T12 on the optical axis from the second side surface of the first lens to the first side surface of the second lens may satisfy: 0.90≤(T23m+T23n)/T12≤3.73.

In an implementation, a radius of curvature R6 of the second side surface of the third lens, a radius of curvature R5 of the first side surface of the third lens, and the amount of change Δf in the effective focal length of the visual system when switching from the first state to the second state may satisfy: −0.55 mm<(R6/R5)×Δf<−0.15 mm.

In an implementation, a distance TDn on the optical axis from the first side surface of the first lens to the second side surface of the third lens in the second state of the visual system, a center thickness CT2 of the second lens on the optical axis, a center thickness CTR of the reflective polarizing element on the optical axis, and a center thickness CTQ of the quarter-wave plate on the optical axis may satisfy: 3.7<TDn/(CT2+CTR+CTQ)<4.5.

In an implementation, the effective focal length fm of the visual system in the first state, and a distance T23m on the optical axis from the second side surface of the second lens to the first side surface of the third lens in the first state of the visual system may satisfy: 5.65≤fm/T23m≤6.91.

In an implementation, a distance BFLn on the optical axis from the second side surface of the third lens to the display in the second state of the visual system, and a distance T23n on the optical axis from the second side surface of the second lens to the first side surface of the third lens in the second state of the visual system may satisfy: 4.06≤BFLn/T23n≤6.05.

In an implementation, the amount of change Δf in the effective focal length of the visual system when switching from the first state to the second state, and a distance BFLm on the optical axis from the second side surface of the third lens to the display in the first state of the visual system may satisfy: 1.1<Δf/BFLm<1.25.

In an implementation, a distance TDn on the optical axis from the first side surface of the first lens to the second side surface of the third lens in the second state of the visual system, and an entrance pupil diameter EPD of the visual system may satisfy: 1.5<TDn/EPD<3.65.

In an implementation, the effective focal length f3 of the third lens, a radius of curvature R5 of the first side surface of the third lens and a radius of curvature R6 of the second side surface of the third lens may satisfy: 0.25<f3/(R5+R6)<1.1.

In an implementation, a radius of curvature R6 of the second side surface of the third lens, and the center thickness CT3 of the third lens on the optical axis may satisfy: −17.06≤R6/CT3≤−16.60.

In an implementation, a distance TDn on the optical axis from the first side surface of the first lens to the second side surface of the third lens in the second state of the visual system, and a distance ΔL by which the third lens moves along the optical axis in a process of the visual system switching from the first state to the second state may satisfy: 5.3<TDn/ΔL<7.25.

The present application discloses a visual system. The visual system comprises, in order from a first side to a second side along an optical axis, a first lens, a reflective polarizing element, a quarter-wave plate, a second lens, a third lens and a partially reflective element, wherein the first lens has a positive refractive power, with a first side surface being convex; the second lens has a positive refractive power or a negative refractive power, with a first side surface being planar; the third lens has a positive refractive power, with a first side surface being convex and a second side surface being convex; the third lens is configured to be able to move along the optical axis to approach or move away from a display located on the second side, so that the visual system switches between a first state and a second state; an effective focal length f3 of the third lens and an effective focal length fm of the visual system in the first state satisfy a conditional expression of 4.95≤f3/fm≤6.24; and a center thickness CT3 of the third lens on the optical axis and an amount of change Δf in the effective focal length of the visual system when switching from the first state to the second state satisfy a conditional expression of 3.20≤CT3/Δf≤3.56. By reasonably configuring the visual system and controlling 3.20≤CT3/Δf≤3.56 while satisfying the condition of 4.95≤f3/fm≤6.24, it helps to control the focusing range and accuracy of the system, improve the applicability and adjustability of the system, and enable users with different eyesight to obtain good visual effects. In addition, the center thickness of a lens element is limited to a reasonable range, so that the center thicknesses are not too thick, which makes the lens elements and the system too heavy and reduces the customer experience; and the lens elements are not too thin, which affects the life of the lens elements during frequent movement of the lens elements. The above settings of the visual system help to optimize the design of the VR visual system and improve the user experience and applicability.

### BRIEF DESCRIPTION OF THE DRAWINGS

Other features, objectives, and advantages of the present application will become more apparent from the following detailed description of non-restrictive embodiments with reference to the drawings. In the drawings:

FIG. 1 shows a schematic structural diagram of a visual system according to Embodiment 1 of the present application when it is in a first state (+2D state);

FIG. 2 shows an MTF (Modulation Transfer Function) curve of the visual system of Embodiment 1 when it is in the first state (+2D state);

FIG. 3 shows a schematic structural diagram of the visual system according to Embodiment 1 of the present application when it is in a second state (−5D state);

FIG. 4 shows an MTF curve of the visual system of Embodiment 1 when it is in the second state (−5D state);

FIG. 5 shows a schematic structural diagram of a visual system according to Embodiment 2 of the present application when it is in a first state (+2D state);

FIG. 6 shows an MTF curve of the visual system of Embodiment 2 when it is in the first state (+2D state);

FIG. 7 shows a schematic structural diagram of the visual system according to Embodiment 2 of the present application when it is in a second state (−5D state);

FIG. 8 shows an MTF curve of the visual system of Embodiment 2 when it is in the second state (−5D state);

FIG. 9 shows a schematic structural diagram of a visual system according to Embodiment 3 of the present application when it is in a first state (+2D state);

FIG. 10 shows an MTF curve of the visual system of Embodiment 3 when it is in the first state (+2D state);

FIG. 11 shows a schematic structural diagram of the visual system according to Embodiment 3 of the present application when it is in a second state (−5D state);

FIG. 12 shows an MTF curve of the visual system of Embodiment 3 when it is in the second state (−5D state);

FIG. 13 shows a schematic structural diagram of a visual system according to Embodiment 4 of the present application when it is in a first state (+2D state);

FIG. 14 shows an MTF curve of the visual system of Embodiment 4 when it is in the first state (+2D state);

FIG. 15 shows a schematic structural diagram of the visual system according to Embodiment 4 of the present application when it is in a second state (−5D state); and

FIG. 16 shows an MTF curve of the visual system of Embodiment 4 when it is in the second state (−5D state).

### DETAILED DESCRIPTION

In order to better understand the present application, various aspects of the present application will be described in more detail with reference to the drawings. It should be understood that the detailed description is merely a representation of exemplary implementations of the present application, and does not limit the scope of the present application in any way. Throughout the specification, identical reference signs refer to identical elements. The expression “and/or” includes any and all combinations of one or more of the associated listed items.

It should be noted that in the present description, the expressions of “first,” “second,” etc., are only used to distinguish one feature from another feature, and do not indicate any limitation on the feature. Therefore, without departing from the teachings of the present application, a first lens to be discussed below may also be referred to as a second lens, and the second lens may also be referred to as the first lens.

In the drawings, for convenience of explanation, the thickness, size, and shape of the respective lens have been slightly exaggerated. Specifically, the shapes of spherical or aspherical surfaces shown in the drawings are shown by way of example. That is, the shapes of the spherical or aspherical surfaces are not limited to those shown in the drawings. The drawings are only examples and are not drawn strictly to scale.

Herein, a paraxial region refers to a region near an optical axis. If a lens surface exhibits a convex surface and the position of the convex surface is not defined, then it means that the lens surface is convex at least in the paraxial region; and if a lens surface exhibits a concave surface and the position of the concave surface is not defined, then it means that the lens surface is concave at least in the paraxial region.

It should also be understood that the terms “comprising”, “comprise”, “having”, “including” and/or “include” when used in the present description, indicate the existence of stated features, elements and/or components, but does not exclude the presence or addition of one or more other features, elements, components and/or combinations thereof. Furthermore, when an expression such as “at least one of” appears after a list of listed features, it modifies the entire list of features, rather than individual elements in the list. In addition, when an implementation of the present application is described, “may” is used to indicate “one or more implementations of the present application”. Also, the term “exemplary” is intended to refer to an example or illustration.

Unless otherwise defined, all terms (including technical and scientific terms) used herein have the same meanings as commonly understood by those of ordinary skill in the art to which the present application belongs. It should also be understood that the terms (such as those defined in commonly used dictionaries) should be interpreted to have meanings consistent with their meanings in the context of the relevant art and will not be interpreted in an idealized or overly formal sense unless it is clearly defined herein.

It should be noted that, in the case of no conflict, the embodiments in the present application and the features in the embodiments may be combined with each other. The present application will be described in detail below in conjunction with embodiments with reference to the drawings.

The features, principles and other aspects of the present application will be described in detail below.

A visual system according to an exemplary embodiment of the present application may include a first lens, a reflective polarizing element, a quarter-wave plate, a second lens, a third lens and a partially reflective element. In an exemplary implementation, the first lens, the reflective polarizing element, the quarter-wave plate, the second lens, the third lens, and the partially reflective element may be arranged in order from a first side to a second side along an optical axis.

In an exemplary implementation, the first lens may have a positive refractive power, and a first side surface which may exhibit a convex surface.

In an exemplary implementation, the second lens may have a positive refractive power or a negative refractive power, and a first side surface which may exhibit a planar surface.

In an exemplary implementation, the third lens may have a positive refractive power, a first side surface which may exhibit a convex surface, and a second side surface which may exhibit a convex surface.

In an exemplary implementation, the quarter-wave plate may be disposed on or attached to the first side surface of the second lens; and the reflective polarizing element may be disposed on or attached to the first side surface of the quarter-wave plate. As an example, the second side surface of the quarter-wave plate may be at least partially in contact with the first side surface of the second lens; and the second side surface of the reflective polarizing element may be at least partially in contact with the first side surface of the quarter-wave plate.

In an exemplary implementation, the partially reflective element may be disposed on the second side surface of the third lens. As an example, the partially reflective element may be a partially transmissive and partially reflective film layer coated on the second side surface of the third lens.

By reasonably setting the structure of the visual system, the light path can be folded, and the body length of the visual system can be effectively shortened, reducing the volume and weight of the visual system, and making the visual system lightweight and portable.

In an exemplary implementation, the first side may be, for example, a human eye side, and the second side may be, for example, a display side. The visual system may be used in, for example, a VR device, etc.

In an exemplary implementation, the respective distances, on the optical axis, of the first lens and the second lens to the display or image plane on the second side of the visual system may be fixed. The third lens may be configured to be able to move along the optical axis to approach or move away from the display or image plane on the second side of the visual system, so that the visual system switches between the first state and the second state. Specifically, when the third lens moves to a position closest to the display or image plane, the distance on the optical axis between the third lens and the second lens is the largest, and the visual system may be in a +2D state, namely, the first state; when the third lens moves to a position farthest from the display or image plane, the distance on the optical axis between the third lens and the second lens is the smallest, and the visual system may be in a −5D state, namely, the second state.

As an example, when the visual system is in the first state, the diopter of the visual system is +2D, which is suitable for users with a +2D diopter, for example; when the visual system is in the second state, the diopter of the visual system is −5D, which is suitable for users with a −5D diopter, for example. When the sign of the diopter is a negative sign, it may indicate that the user is a myopic user; when the sign of the diopter is a positive sign, it may indicate that the user is a hyperopic user; the specific value of the diopter may indicate the user's diopter degree. For example, a +1D diopter may indicate that the user's hyperopia is approximately 100 degrees, and a −1D diopter may indicate that the user's myopia is approximately 100 degrees.

It should be understood that in addition to the first state and the second state, the visual system according to the implementation of the present application may also have other states, such as between −5D and +2D. The visual system according to the implementation of the present application can achieve continuous zoom within the range of −5D to +2D, which can satisfy the needs of users with different eyesight and enable users to enjoy the VR experience without wearing glasses.

In an exemplary implementation, the visual system of the present application may include at least one stop (aperture stop). The stop may constrain the light path and control the magnitude of light intensity. The stop may be disposed at an appropriate position in the visual system. For example, the stop may be located between the first side (e.g., a human eye side) and the first lens.

In an exemplary implementation, the visual system has different virtual image distances (VID) in the first and second states. The VID may be, for example, the distance from a virtual image formed by image light from the second side at a predetermined position to the stop on the optical axis. In this context, VID=1000/diopter.

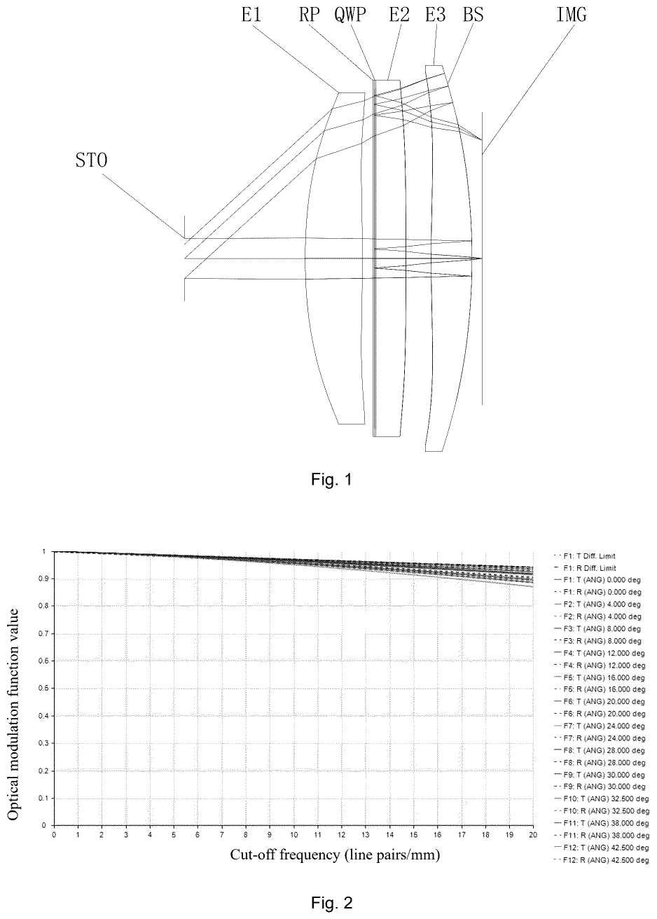

The visual system will be described below with reference to FIG. 1. As shown in FIG. 1, the visual system according to an exemplary implementation of the present application may include a first lens E1, a reflective polarizing element RP, a quarter-wave plate QWP, a second lens E2, a third lens E3, and a partially reflective element BS arranged in order from a first side to a second side, wherein the quarter-wave plate QWP is disposed on a first side surface of the second lens E2, the reflective polarizing element RP is disposed on a first side surface of the quarter-wave plate QWP, and the partially reflective element BS is disposed on a second side surface of the third lens E3. In actual use, the visual system according to an exemplary implementation of the present application may be used as a VR lens assembly, for example. In this case, the first side corresponds to a human eye side and the second side corresponds to a display or image plane side. The visual system may also include, for example, a display or image plane IMG located on the second side of the partially reflective element BS. A light beam emitted from the IMG may sequentially pass through the partially reflective element BS, the third lens E3, the second lens E2, and the quarter-wave plate QWP to reach the reflective polarizing element RP. The light beam is reflected at the reflective polarizing element RP and again passes through the quarter-wave plate QWP, the second lens E2, and the third lens E3 to reach the partially reflective element BS. Thereafter, the light beam is again reflected at the partially reflective element BS and sequentially passes through the third lens E3, the second lens E2, the quarter-wave plate QWP, the reflective polarizing element RP, and the first lens E1 to exit toward the first side (e.g., a stop STO in FIG. 1). The visual system provided by the present application folds the required optical path without affecting projection quality by means of a combination of light reflection and refraction, effectively shortening the body length of the visual system.

In an exemplary implementation, the visual system of the present application may satisfy a conditional expression of 4.95≤f3/fm≤6.24, where f3 is the effective focal length of the third lens, and fm is the effective focal length of the visual system in a +2D state.

In an exemplary implementation, the visual system of the present application may satisfy a conditional expression of 3.20≤CT3/Δf≤3.56, where CT3 is the center thickness of the third lens on the optical axis; Δf is an amount of change in the effective focal length of the visual system when switching from the +2D state to a −5D state, namely, the difference between the effective focal length fm of the visual system in the +2D state and the effective focal length fn of the visual system in the −5D state.

A visual system according to an exemplary implementation of the present application includes, in order from a first side to a second side along an optical axis, a first lens, a reflective polarizing element, a quarter-wave plate, a second lens, a third lens and a partially reflective element, wherein the first lens has a positive refractive power, with a first side surface being convex; the second lens has a positive refractive power or a negative refractive power, with a first side surface being planar; the third lens has a positive refractive power, with a first side surface being convex and a second side surface being convex; the third lens is configured to be able to move along the optical axis to approach or move away from a display located on the second side, so that the visual system switches between a first state and a second state; an effective focal length f3 of the third lens and an effective focal length fm of the visual system in the first state satisfy a conditional expression of 4.95≤f3/fm≤6.24; and a center thickness CT3 of the third lens on the optical axis and an amount of change Δf in the effective focal length of the visual system when switching from the first state to the second state satisfy a conditional expression of 3.20≤CT3/Δf≤3.56. By reasonably configuring the visual system and controlling 3.20≤CT3/Δf≤3.56 while satisfying the condition of 4.95≤f3/fm≤6.24, it helps to control the focusing range and accuracy of the system, improve the applicability and adjustability of the system, and enable users with different eyesight to obtain good visual effects. In addition, the center thickness of a lens element is limited to a reasonable range, so that the center thicknesses are not too thick, which makes the lens elements and the system too heavy and reduces the customer experience; and the lens elements are not too thin, which affects the life of the lens elements during frequent movement of the lens elements. The above settings of the visual system help to optimize the design of the VR visual system and improve the user experience and applicability.

In an exemplary implementation, the visual system of the present application may satisfy a conditional expression of 1.45<R1/(fm+fn)<1.95, where R1 is a radius of curvature of the first side surface of the first lens, fm is the effective focal length of the visual system in the +2D state, and fn is the effective focal length of the visual system in the −5D state. By controlling this conditional expression, the design of the first lens is optimized to ensure that the ratio of R1 to the sum of fm and fn is within this range, which can effectively control the refraction and focusing of light, improving the imaging quality and clarity of the optical system while also facilitating to ensure the stability and performance of the system at the states of different focal lengths. By controlling this conditional expression, the optical performance of the VR visual system can be effectively enhanced, improving the user experience and visual effects.

In an exemplary implementation, the visual system of the present application may satisfy a conditional expression of 2.74≤(CT1+CT2)/ΔL≤4.30, where CT1 is the center thickness of the first lens on the optical axis, CT2 is the center thickness of the second lens on the optical axis, and ΔL is the distance by which the third lens moves along the optical axis when the visual system switches from the +2D state to the −5D state. By reasonably controlling the range of this conditional expression, the center thickness of a lens element can be ensured within a reasonable range, preventing the excessive center thicknesses of the lens elements from causing excessive weight of the lens elements and the system and reducing the user experience, while also preventing excessively thin lens elements from increasing the difficulty of assembling and film coating. Meanwhile, by controlling the distance by which the third lens moves along the optical axis when the system switches from the +2D state to the −5D state, the total length of the system can be prevented from being too long and the weight of the system can be prevented from increasing, thereby facilitating to ensure the user experience.

In an exemplary implementation, the visual system of the present application may satisfy a conditional expression of 4.25<f1/TDm<8.1, where f1 is the effective focal length of the first lens, and TDm is the distance on the optical axis from the first side surface of the first lens to the second side surface of the third lens in the +2D state of the visual system. By reasonably controlling the range of this conditional expression, such a design can optimize the refraction and transmission of light, ensuring proper focusing and imaging of light inside the system, and improving the efficiency and performance of the optical system. It can also effectively adjust the focal length and focusing ability of the system, so that the system can better adapt to different eyesight needs and usage scenarios, providing a clearer and more comfortable virtual reality experience.

In an exemplary implementation, the visual system of the present application may satisfy a conditional expression of 0.90≤(T23m+T23n)/T12≤3.73, where T23m is the distance on the optical axis from the second side surface of the second lens to the first side surface of the third lens in the +2D state of the visual system, T23n is the distance on the optical axis from the second side surface of the second lens to the first side surface of the third lens in the −5D state of the visual system, and T12 is the distance on the optical axis from the second side surface of the first lens to the first side surface of the second lens. By reasonably controlling the range of this conditional expression, such a design can ensure that the minimum air spacing between lens elements during focusing is not too small, preventing collisions with lens elements or other elements and preventing the service life of the elements from being reduced. It also ensures that the air spacing between the lens elements during focusing is not too large, preventing the overall length of the VR system from being too long or too heavy, thereby facilitating to ensure the system performance and the user experience.

In an exemplary implementation, the visual system of the present application may satisfy a conditional expression of −0.55 mm<(R6/R5)×Δf<−0.15 mm, where R6 is the radius of curvature of the second side surface of the third lens, R5 is the radius of curvature of the first side surface of the third lens, and Δf is an amount of change in effective focal length when the visual system switches from the +2D state to the −5D state. By reasonably controlling the range of this conditional expression, such a design can help optimize transmission and focusing of light, ensuring the correct path and focal position of the light inside the system, and improving the performance and stability of the optical system.

In an exemplary implementation, the visual system of the present application may satisfy a conditional expression of 3.7<TDn/(CT2+CTR+CTQ)<4.5, where TDn is the distance on the optical axis from the first side surface of the first lens to the second side surface of the third lens in the −5D state of the visual system, CT2 is the center thickness of the second lens on the optical axis, CTR is the center thickness of the reflective polarizing element on the optical axis, and CTQ is the center thickness of the quarter-wave plate on the optical axis. By reasonably controlling the range of this conditional expression, particularly the thicknesses of the second lens, the reflective polarizing element, and the quarter-wave plate, the overall length and weight of the lens elements and the system can be controlled to satisfy the optical characteristics of the system. On this basis, this can also reduce the difficulty of film coating and ensure the service life of the film and the lens elements.

In an exemplary implementation, the visual system of the present application may satisfy a conditional expression of 5.65≤fm/T23m≤6.91, where fm is the effective focal length of the visual system in the +2D state, and T23m is the distance on the optical axis from the second side surface of the second lens to the first side surface of the third lens in the +2D state. By reasonably controlling the range of this conditional expression, the overall length of the system after zooming can also be controlled while controlling the light propagation angle to satisfy the performance requirement in the +2D state.

In an exemplary implementation, the visual system of the present application may satisfy a conditional expression of 4.06≤BFLn/T23n≤6.05, where BFLn is the distance on the optical axis from the second side surface of the third lens to the display in the −5D state of the visual system, and T23n is the distance on the optical axis from the second side surface of the second lens to the first side surface of the third lens in the −5D state of the visual system. By reasonably controlling the range of this conditional expression, this design can help optimize the transmission and focusing of light, ensuring the correct path and focal position of light inside the system, and improving the performance and stability of the optical system. By controlling the ratio range of this conditional expression, the focal length and focusing ability of the system can also be adjusted, thereby improving the imaging quality and optical efficiency, and providing users with a clearer and more comfortable virtual reality experience. The limitation of this conditional expression helps to improve the optical performance of the entire VR visual system, enabling users to better enjoy the visual feast brought by the virtual environment.

In an exemplary implementation, the visual system of the present application may satisfy a conditional expression of 1.1<Δf/BFLm<1.25, where Δf is an amount of change in the effective focal length of the visual system when switching from the +2D state to the −5D state, and BFLm is the distance on the optical axis from the second side surface of the third lens to the display in the +2D state of the visual system. By reasonably controlling the range of this conditional expression, it is possible to help adjust the ratio between the change in the focal length and the optical path length of the system, ensuring the imaging quality and stability of the system in different focal length states. By controlling the ratio range of this conditional expression, the focal length adjustment effect of the system in different states can be optimized, improving imaging clarity and accuracy, and enhancing the user's immersion and comfort in the virtual reality environment. The definition of this conditional expression helps to improve the optical performance of the entire VR visual system, enabling users to better experience the visual effects and fun brought by the virtual reality world.

In an exemplary implementation, the visual system of the present application may satisfy a conditional expression of 1.5<TDn/EPD<3.65, where TDn is the distance on the optical axis from the first side surface of the first lens to the second side surface of the third lens in the −5D state of the visual system, and EPD is the entrance pupil diameter of the visual system. By reasonably controlling the range of this conditional expression, it can help optimize the transmission and focusing of light, ensuring the correct path and focal position of light inside the system, and improving the performance and stability of the optical system. By controlling the ratio range of this conditional expression, the optical parameters of the system can be adjusted to improve the imaging quality and optical efficiency, thereby enhancing the user's visual experience in the virtual reality environment. This conditional expression helps improve the optical performance of the entire VR visual system, enabling users to immerse themselves in the virtual world more clearly and comfortably.

In an exemplary implementation, the visual system of the present application may satisfy a conditional expression of 0.25<f3/(R5+R6)<1.1, where f3 is the effective focal length of the third lens, R5 is the radius of curvature of the first side surface of the third lens, and R6 is the radius of curvature of the second side surface of the third lens. By reasonably controlling the range of this conditional expression, it can help optimize the shape and curvature of the lens, ensuring that light is correctly focused and refracted inside the lens, and improving the imaging quality and performance stability of the optical system. By controlling the ratio range of this conditional expression, the optical parameters of the lens can be adjusted, and the imaging ability and focusing effect of the lens can be optimized, thereby improving the user's visual experience in the virtual reality environment. The limitation of this conditional expression helps to improve the optical performance of the entire VR visual system, enabling users to enjoy the visual feast brought by the virtual reality world more clearly and comfortably.

In an exemplary implementation, the visual system of the present application may satisfy a conditional expression of −17.06≤R6/CT3≤−16.60, where R6 is the radius of curvature of the second side surface of the third lens, and CT3 is the center thickness of the third lens on the optical axis. By reasonably controlling the range of this conditional expression, the shape and curvature distribution of the lens can be optimized, ensuring that light is correctly refracted and focused inside the lens, and improving the imaging quality and performance stability of the optical system. By controlling the ratio range of this conditional expression, the optical parameters of the lens can be adjusted, and the imaging capability and optical effect of the lens can be optimized, thereby improving the user's visual experience in the virtual reality environment. The definition of this conditional expression helps to improve the optical performance of the entire VR visual system, enabling users to immerse themselves in the virtual world more clearly and comfortably, and to enjoy a more realistic visual experience.

In an exemplary implementation, the visual system of the present application may satisfy a conditional expression of 5.3<TDn/ΔL<7.25, where TDn is the distance on the optical axis from the first side surface of the first lens to the second side surface of the third lens in the −5D state of the visual system, and ΔL is the distance by which the third lens moves along the optical axis when the visual system switches from the +2D state to the −5D state. By reasonably controlling the range of this conditional expression, it can help optimize the focusing range and optical parameters of the lens system, ensuring that the system can still focus and image correctly in the states of different degrees, and thereby improving the adaptability and stability of the optical system; By controlling the ratio range of this conditional expression, the position and optical characteristics of the lens can be adjusted, and the focal length adjustment ability and imaging quality of the system can be optimized, thereby improving the user's visual experience in the virtual reality environment. The limitation of this conditional expression helps to improve the optical performance of the entire VR visual system, enabling users to obtain a clear and comfortable visual experience in the states of different focal lengths, and thereby enhancing the application value of virtual reality technology.

In the visual system according to the implementations of the present application, there may be one or more aspherical surfaces among the surfaces of the first lens, the second lens, and the third lens. The characteristic of an aspherical lens is that the curvature changes continuously from the center of the lens to the periphery of the lens. Unlike a spherical lens having a constant curvature from the center of the lens to the periphery of the lens, the aspherical lens has a better curvature radius characteristic, and has the advantages of ameliorating distortion aberration and ameliorating astigmatism aberration. After the aspherical lens is adopted, the aberrations that occur during imaging can be eliminated as much as possible, thereby improving the imaging quality.

In one aspect, a visual system according to an exemplary implementation of the present application includes, in order from a first side to a second side along an optical axis, a first lens, a reflective polarizing element, a quarter-wave plate, a second lens, a third lens and a partially reflective element, wherein the first lens has a positive refractive power, with a first side surface being convex; the second lens has a positive refractive power or a negative refractive power, with a first side surface being planar; the third lens has a positive refractive power, with a first side surface being convex and a second side surface being convex; the third lens is configured to be able to move along the optical axis to approach or move away from a display located on the second side, so that the visual system switches between a first state and a second state; an effective focal length f3 of the third lens and an effective focal length fm of the visual system in the first state satisfy a conditional expression of 4.95≤f3/fm≤6.24; and a center thickness CT3 of the third lens on the optical axis and an amount of change Δf in the effective focal length of the visual system when switching from the first state to the second state satisfy a conditional expression of 3.20≤CT3/Δf≤3.56. By reasonably configuring the visual system and controlling 3.20≤CT3/Δf≤3.56 while satisfying the condition of 4.95≤f3/fm≤6.24, it helps to control the focusing range and accuracy of the system, improve the applicability and adjustability of the system, and enable users with different eyesight to obtain good visual effects. In addition, the thickness of a lens element is limited to a reasonable range, so that the center thickness is not too thick, which makes the lens elements and system too heavy and reduces the customer experience; and the lens elements are not too thin, which affects the life of the lens elements during frequent movement of the lens elements. The above settings of the visual system help to optimize the design of the VR visual system and improve the user experience and applicability.

In another aspect, a visual system according to an exemplary implementation of the present application includes, in order from a first side to a second side along an optical axis, a first lens, a reflective polarizing element, a quarter-wave plate, a second lens, a third lens and a partially reflective element, wherein the first lens has a positive refractive power, with a first side surface being convex; the second lens has a positive refractive power or a negative refractive power, with a first side surface being planar; the third lens has a positive refractive power, with a first side surface being convex and a second side surface being convex; the third lens is configured to be able to move along the optical axis to approach or move away from a display located on the second side, so that the visual system switches between a first state and a second state; an effective focal length f3 of the third lens and an effective focal length fm of the visual system in the first state satisfy a conditional expression of 4.95≤f3/fm≤6.24; and a center thickness CT1 of the first lens on the optical axis, a center thickness CT2 of the second lens on the optical axis, and a distance ΔL by which the third lens moves along the optical axis in a process of the visual system switching from a +2D state to a −5D state satisfy a conditional expression of 2.74≤(CT1+CT2)/ΔL≤4.30. By reasonably configuring the visual system and controlling 2.74$ (CT1+CT2)/ΔL≤4.30 while satisfying the condition of 4.95≤f3/fm≤6.24, it helps to control the focusing range and accuracy of the system, improve the applicability and adjustability of the system, and enable users with different eyesight to obtain good visual effects. Meanwhile, the center thickness of a lens element can be ensured within a reasonable range, preventing the excessive center thicknesses of the lens elements from causing excessive weight of the lens elements and the system and reducing the user experience, while also preventing excessively thin lens elements from increasing the difficulty of assembling and film coating. Meanwhile, by controlling the distance by which the third lens moves along the optical axis when the system switches from the +2D state to the −5D state, the total length of the system can be prevented from being too long and the weight of the system can be prevented from increasing, thereby facilitating to ensure the user experience.

The visual system according to the exemplary implementation of the present application adopts, for example, a three-piece fold-back structure. Through the reasonable configuration of the system structure and parameters, it can not only reduce the total optical length and the overall weight of the system, realizing the miniaturization and lightweight of the system, and improving the user comfort; but can also realize the zoom range of −5D to +2D through the movement of the third lens, satisfying the needs of users with different eyesight, so that users can enjoy the VR experience without wearing glasses.

In addition, the present application further provides a VR device. The VR device may include the visual system provided by any of the above-mentioned implementations, wherein the first side may be a human eye side, and the second side may be a display/image plane side. The VR device may have the characteristics of miniaturization, lightweight, and high imaging quality, and may achieve zoom within a range of −5D to +2D, enabling users with different eyesight conditions to clearly enjoy the VR experience without wearing glasses, thereby providing users with a better application experience.

Specific embodiments of the visual system applicable to the above-mentioned implementations will be further described below with reference to the drawings.

### Embodiment 1

A visual system according to Embodiment 1 of the present application will be described below with reference to FIGS. 1 to 4.

The visual system according to Embodiment 1 of the present application includes, in order from a first side to a second side along an optical axis, a first lens E1, a reflective polarizing element RP, a quarter-wave plate QWP, a second lens E2, a third lens E3, and a partially reflective element BS. The first lens E1 has a positive refractive power, with a first side surface being convex and a second side surface being convex. The second lens E2 has a positive refractive power, with a first side surface being planar and a second side surface being convex. The third lens E3 has a positive refractive power, with a first side surface being convex and a second side surface being convex. The quarter-wave plate QWP is disposed on the first side surface of the second lens E2. The reflective polarizing element RP is disposed on a first side surface of the quarter-wave plate QWP. The partially reflective element BS is disposed on the second side surface of the third lens E3.

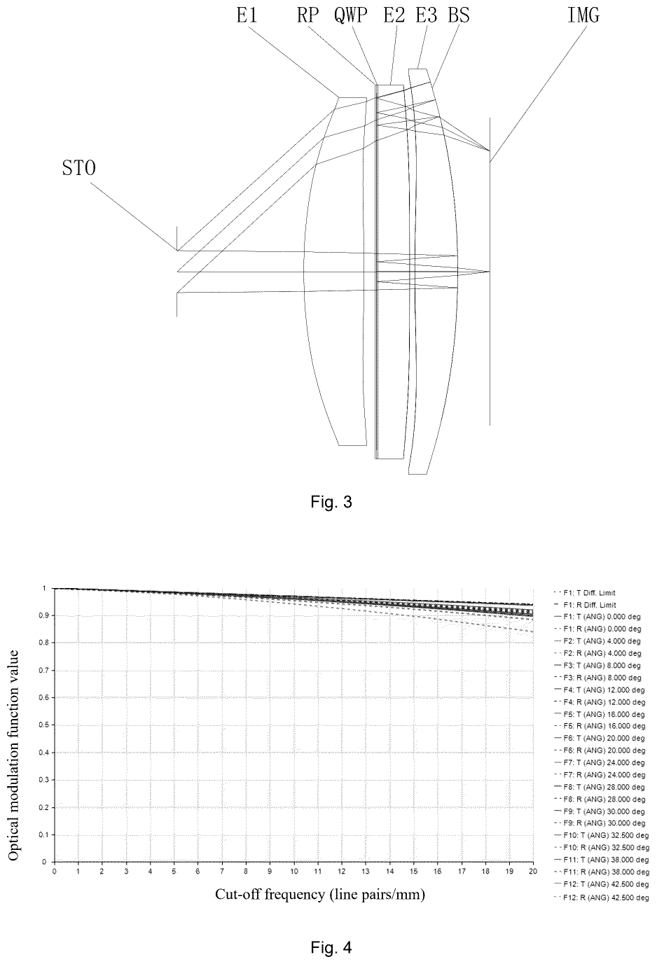

In this example, a stop STO may be provided on the first side of the visual system, and a display/image plane IMG may be provided on the second side of the visual system. The respective distances, along the optical axis, of the first lens E1, the reflective polarizing element RP, the quarter-wave plate QWP, and the second lens E2 to the display/image plane IMG are relatively fixed. The third lens E3 and the partially reflective element BS may be moved along the optical axis to approach or move away from the display/image plane IMG. During this process, the visual system can achieve zooming within the range of −5D to +2D. FIG. 1 shows a schematic structural diagram of the visual system when the third lens E3 and the partially reflective element BS are moved along the optical axis to a position closest to the display/image plane IMG. In this case, the visual system is in a +2D state. FIG. 3 shows a schematic structural diagram of the visual system when the third lens E3 and the partially reflective element BS are moved along the optical axis to a position farthest from the display/image plane IMG. In this case, the visual system is in a −5D state.

As shown in FIGS. 1 and 3, in a specific application of the visual system according to this example, image light, for example, from the display/image plane IMG, may sequentially pass through the partially reflective element BS, the third lens E3, the second lens E2, and the quarter-wave plate QWP to reach the reflective polarizing element RP. Then, the light is reflected by the reflective polarizing element RP and again passes through the quarter-wave plate QWP, the second lens E2, and the third lens E3 before reaching the partially reflective element BS. Thereafter, the light is reflected again at the partially reflective element BS and sequentially passes through the third lens E3, the second lens E2, the quarter-wave plate QWP, the reflective polarizing element RP, and the first lens E1 to the stop, ultimately forming an image at a predetermined position. For example, in this visual system, the light after the two reflections may ultimately be projected onto a user's pupil.

Table 1 shows the basic parameters of the visual system of Embodiment 1, wherein the units of the radius of curvature and thickness/distance are all in millimeters (mm).

TABLE 1

| | | Surface | Radius of | Thickness/ | Refractive | Dispersion | Refraction/ | Cone |
|---|---|---|---|---|---|---|---|---|
| Surface | Element | type | curvature | distance | index | coefficient | reflection | coefficient |
| S0 | | Spherical | Infinite | D1 | | | Refraction | |
| S1 | Stop (STO) | Spherical | Infinite | 12.0000 | | | Refraction | |
| S2 | First lens (E1) | Aspherical | 50.1692 | 5.7000 | 1.548 | 56.30 | Refraction | −0.5341 |
| S3 | | Aspherical | −162.6674 | 1.0621 | | | Refraction | −39.9151 |
| S4 | Reflective polarizing | Spherical | Infinite | 0.1180 | 1.495 | 57.47 | Refraction | |
| | element (RP) | | | | | | | |
| S5 | Quarter-wave plate | Spherical | Infinite | 0.1340 | 1.495 | 57.47 | Refraction | |
| | (QWP) | | | | | | | |
| S6 | Second lens (E2) | Spherical | Infinite | 3.0000 | 1.548 | 56.30 | Refraction | |
| S7 | | Aspherical | −488013.5880 | D2 | | | Refraction | 99.0000 |
| S8 | Third lens (E3) | Aspherical | 168.5332 | 4.0606 | 1.548 | 56.30 | Refraction | −41.4049 |
| S9 | Partially reflective | Aspherical | −69.2832 | −4.0606 | 1.548 | 56.30 | Reflection | 2.3882 |
| | element (BS) | | | | | | | |
| S10 | | Aspherical | 168.5332 | D3 | | | Refraction | −41.4049 |
| S11 | | Aspherical | −488013.5880 | −3.0000 | 1.548 | 56.30 | Refraction | 99.0000 |
| S12 | | Spherical | Infinite | −0.1340 | 1.495 | 57.47 | Refraction | |
| S13 | Reflective polarizing | Spherical | Infinite | 0.1340 | 1.495 | 57.47 | Reflection | |
| | element (RP) | | | | | | | |
| S14 | Second lens (E2) | Spherical | Infinite | 3.0000 | 1.548 | 56.30 | Refraction | |
| S15 | | Aspherical | −488013.5880 | D4 | | | Refraction | 99.0000 |
| S16 | Third lens (E3) | Aspherical | 168.5332 | 4.0606 | 1.548 | 56.30 | Refraction | −41.4049 |
| S17 | | Aspherical | −69.2832 | D5 | | | Refraction | 2.3882 |
| S18 | Image plane (IMG) | Spherical | Infinite | 0.0000 | | | Refraction | |

Parameters D1 to D5 in Table 1 can be understood as follows: D5 can be understood as a value taken along the optical axis from the display/image plane IMG to the second side surface of the third lens E3; D4 can be understood as a value taken along the optical axis from the first side surface of the third lens E3 to the second side surface of the second lens E2; D3 can be understood as a value taken along the optical axis from the second side surface of the second lens E2 to the first side surface of the third lens E3; D2 can be understood as a value taken along the optical axis from the first side surface of the third lens E3 to the second side surface of the second lens E2; and D1 can be understood as a value of the virtual image distance of the visual system according to this embodiment. During zooming of the visual system according to this embodiment by moving the third lens E3 and the partially reflective element BS along the optical axis, the values of these parameters D1 to D5 all change accordingly. The values of parameters D1 to D5 for the visual system in the +2D state shown in FIG. 1 and the −5D state shown in FIG. 3 are shown in Table 2 below.

TABLE 2

| | D1 | D2 | D3 | D4 | D5 |
|---|---|---|---|---|---|
| +2D state | 500.0000 | 2.5216 | −2.5216 | 2.5216 | 1.0000 |
| −5D state | −200.0000 | 0.5000 | −0.5000 | 0.5000 | 3.0205 |

In this embodiment, the first side surface S2 and the second side surface S3 of the first lens E1, the second side surface S15 of the second lens E2, and the first side surface S16 and the second side surface S17 of the third lens E3 are all aspherical. The surface profile of each aspherical lens can be defined by, but is not limited to, the following aspherical surface formula:

$$x = \frac{{ch}^{2}}{1 + \sqrt{1 - ( k + 1 ) {c}^{2} {h}^{2}}} + \sum {Aih}^{i} \qquad ( 1 )$$

where x is a distance vector height from a vertex of the aspherical surface when the aspherical surface is at a height of h along the direction of the optical axis; c is paraxial curvature of the aspherical surface, c=1/R (that is, the paraxial curvature c is the reciprocal of the radius of curvature R in Table 1 above); k is a conic coefficient; and Ai is a correction coefficient of an i-th order of the aspherical surface. Higher-order coefficients A₄, A₆, A₈, A₁₀, A₁₂, A₁₄, A₁₆, A₁₈, and A₂₀ that can be used for each of the aspherical lens surfaces S2-S3 and S15-S17 in this embodiment are given in Table 3 below.

TABLE 3

| | surface | | | | |
|---|---|---|---|---|---|
| Coefficient | S2 | S3 | S15 | S16 | S17 |
| A4 | 1.3684E−05 | 2.0827E−05 | −6.8853E−06 | −1.5870E−05 | −2.2182E−06 |
| A6 | −1.6485E−08 | −5.2540E−09 | −1.6186E−08 | 9.8354E−09 | 4.1994E−09 |
| A8 | −1.2739E−11 | −6.4922E−11 | 8.4979E−11 | −1.6458E−12 | −3.6128E−12 |
| A10 | −1.2571E−14 | −4.3976E−14 | −7.2568E−14 | 6.6756E−15 | 1.0073E−14 |
| A12 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 |

FIG. 2 shows an MTF curve of the visual system according to this embodiment when it is in the +2D state shown in FIG. 1, and FIG. 4 shows an MTF curve of the visual system according to this embodiment when it is in the −5D state shown in FIG. 3. The MTF (Modulation Transfer Function) curves can represent optical modulation function values associated with different cut-off frequencies. It can be seen from FIGS. 2 and 4 that the visual system given in this embodiment can achieve good imaging quality in both the +2D and −5D focal length states.

### Embodiment 2

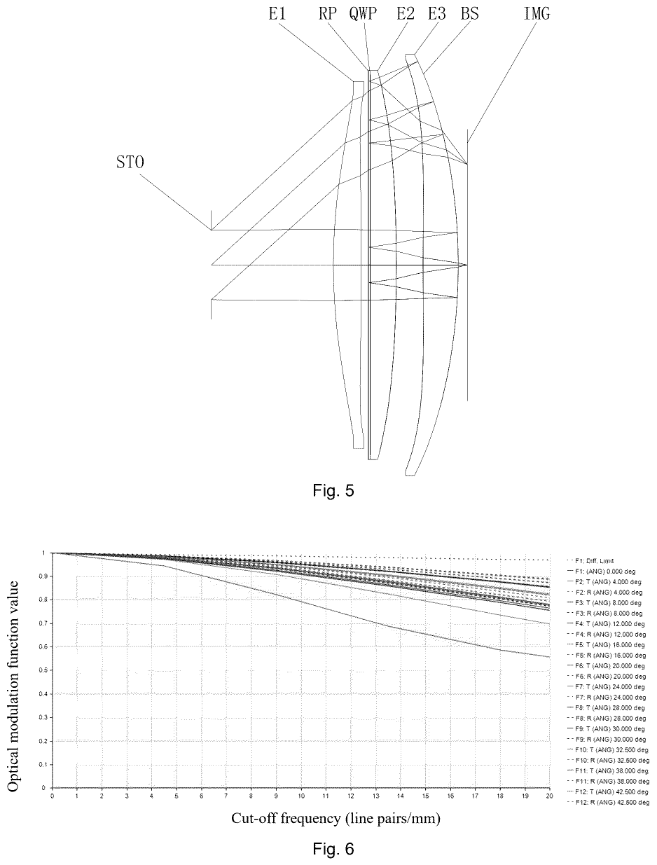

A visual system according to Embodiment 2 of the present application will be described below with reference to FIGS. 5 to 8. In this embodiment and each of the following embodiments, for the sake of brevity, the description of parts similar to those in Embodiment 1 will be omitted.

In this example, the visual system also includes a first lens E1, a reflective polarizing element RP, a quarter-wave plate QWP, a second lens E2, a third lens E3, and a partially reflective element BS arranged in order from a first side to a second side along an optical axis. The first lens E1 has a positive refractive power, with a first side surface being convex and a second side surface being convex. The second lens E2 has a positive refractive power, with a first side surface being planar and a second side surface being convex. The third lens E3 has a positive refractive power, with a first side surface being convex and a second side surface being convex. The quarter-wave plate QWP is disposed on the first side surface of the second lens E2. The reflective polarizing element RP is disposed on a first side surface of the quarter-wave plate QWP. The partially reflective element BS is disposed on the second side surface of the third lens E3.

Table 4 shows basic parameters of the visual system according to this embodiment.

TABLE 4

| | | | Radius of | Thickness/ | Refractive | Dispersion | Refraction/ | Cone |
|---|---|---|---|---|---|---|---|---|
| Surface | Element | Surface type | curvature | distance | index | coefficient | reflection | coefficient |
| S0 | | Spherical | Infinite | D1 | | | Refraction | |
| S1 | Stop (STO) | Spherical | Infinite | 14.0000 | | | Refraction | |
| S2 | First lens (E1) | Aspherical | 64.2849 | 3.1839 | 1.548 | 56.30 | Refraction | 1.5975 |
| S3 | | Aspherical | −4666.7980 | 0.7904 | | | Refraction | −99.0000 |
| S4 | Reflective polarizing | Spherical | Infinite | 0.1180 | 1.495 | 57.47 | Refraction | |
| | element (RP) | | | | | | | |
| S5 | Quarter-wave plate | Spherical | Infinite | 0.1340 | 1.495 | 57.47 | Refraction | |
| | (QWP) | | | | | | | |
| S6 | Second lens (E2) | Spherical | Infinite | 3.0000 | 1.548 | 56.30 | Refraction | |
| S7 | | Aspherical | −180.8496 | D2 | | | Refraction | 56.3472 |
| S8 | Third lens (E3) | Aspherical | 490.9183 | 4.0251 | 1.548 | 56.30 | Refraction | 56.6237 |
| S9 | Partially reflective | Aspherical | −67.2805 | −4.0251 | 1.548 | 56.30 | Reflection | 0.7024 |
| | element (BS) | | | | | | | |
| S10 | | Aspherical | 490.9183 | D3 | | | Refraction | 56.6237 |
| S11 | | Aspherical | −180.8496 | −3.0000 | 1.548 | 56.30 | Refraction | 56.3472 |
| S12 | | Spherical | Infinite | −0.1340 | 1.495 | 57.47 | Refraction | |
| S13 | Reflective polarizing | Spherical | Infinite | 0.1340 | 1.495 | 57.47 | Reflection | |
| | element (RP) | | | | | | | |
| S14 | Second lens (E2) | Spherical | Infinite | 3.0000 | 1.548 | 56.30 | Refraction | |
| S15 | | Aspherical | −180.8496 | D4 | | | Refraction | 56.3472 |
| S16 | Third lens (E3) | Aspherical | 490.9183 | 4.0251 | 1.548 | 56.30 | Refraction | 56.6237 |
| S17 | | Aspherical | −67.2805 | D5 | | | Refraction | 0.7024 |
| S18 | Image plane (IMG) | Spherical | Infinite | 0.0000 | | | Refraction | |

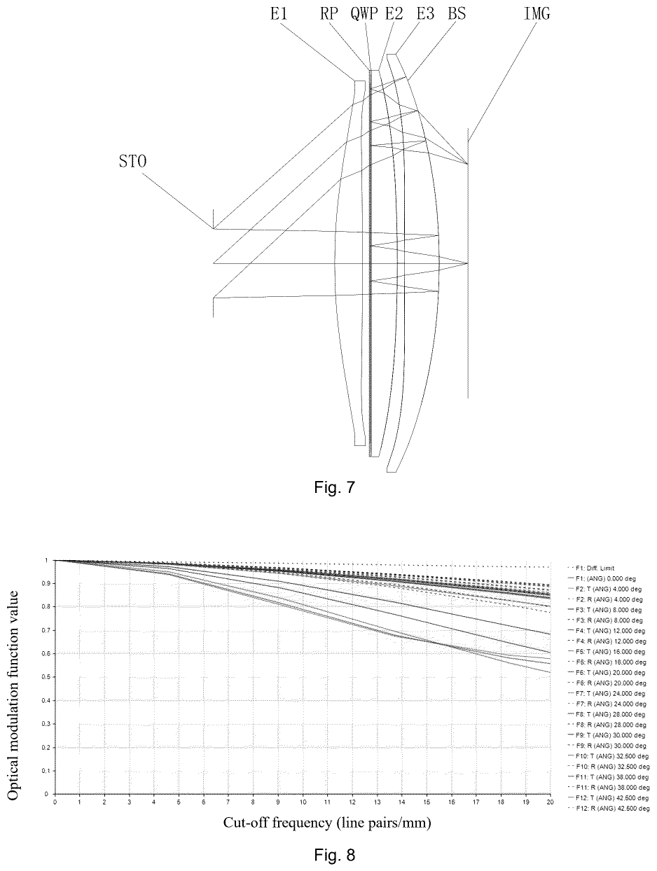

In this example, a stop STO may be provided on the first side of the visual system, and a display/image plane IMG may be provided on the second side of the visual system. The respective distances, along the optical axis, of the first lens E1, the reflective polarizing element RP, the quarter-wave plate QWP, and the second lens E2 to the display/image plane IMG are relatively fixed. The third lens E3 and the partially reflective element BS may be moved along the optical axis to approach or move away from the display/image plane IMG. During this process, the visual system can achieve zooming within the range of −5D to +2D. FIG. 5 shows a schematic structural diagram of the visual system when the third lens E3 and the partially reflective element BS are moved along the optical axis to a position closest to the display/image surface IMG. In this case, the visual system is in a +2D state. FIG. 7 shows a schematic structural diagram of the visual system when the third lens E3 and the partially reflective element BS are moved along the optical axis to a position farthest from the display/image plane IMG. In this case, the visual system is in a −5D state.

The corresponding values of parameters D1 to D5 in Table 4 for the visual system according to this embodiment in the +2D state shown in FIG. 5 and the −5D state shown in FIG. 7 are each shown in Table 5 below.

TABLE 5

| | D1 | D2 | D3 | D4 | D5 |
|---|---|---|---|---|---|
| +2D state | 500.0000 | 3.0726 | −3.0726 | 3.0726 | 1.0425 |
| −5D state | −200.0000 | 0.8135 | −0.8135 | 0.8135 | 3.3010 |

In this embodiment, the first side surface S2 and the second side surface S3 of the first lens E1, the second side surface S15 of the second lens E2, and the first side surface S16 and the second side surface S17 of the third lens E3 are all aspherical surfaces. The surface profile of each aspherical surface can be calculated using formula (1) in Embodiment 1. Higher-order coefficients A₄, A₆, A₈, A₁₀, A₁₂, A₁₄, A₁₆, A₁₈, and A₂₀ that can be used for each of the aspherical lens surfaces S2-S3 and S15-S17 in this embodiment are given in Table 6 below.

TABLE 6

| | surface | | | | |
|---|---|---|---|---|---|
| Coefficient | S2 | S3 | S15 | S16 | S17 |
| A4 | −5.6489E−06 | −6.7623E−06 | −6.1341E−07 | −8.5880E−06 | −3.4515E−07 |
| A6 | −1.3799E−09 | 2.2317E−08 | −2.8462E−09 | 1.4528E−09 | −3.2155E−10 |
| A8 | 0.0000E+00 | 0.0000E+00 | −1.8260E−12 | −1.3237E−12 | −1.5081E−12 |
| A10 | 0.0000E+00 | 0.0000E+00 | 1.7415E−14 | 0.0000E+00 | 0.0000E+00 |
| A12 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 |

FIG. 6 shows an MTF curve of the visual system according to this embodiment when it is in the +2D state shown in FIG. 5, and FIG. 8 shows an MTF curve of the visual system according to this embodiment when it is in the −5D state shown in FIG. 7. It can be seen from FIGS. 6 and 8 that the visual system given in this embodiment can achieve good imaging quality in both the +2D and −5D focal length states.

### Embodiment 3

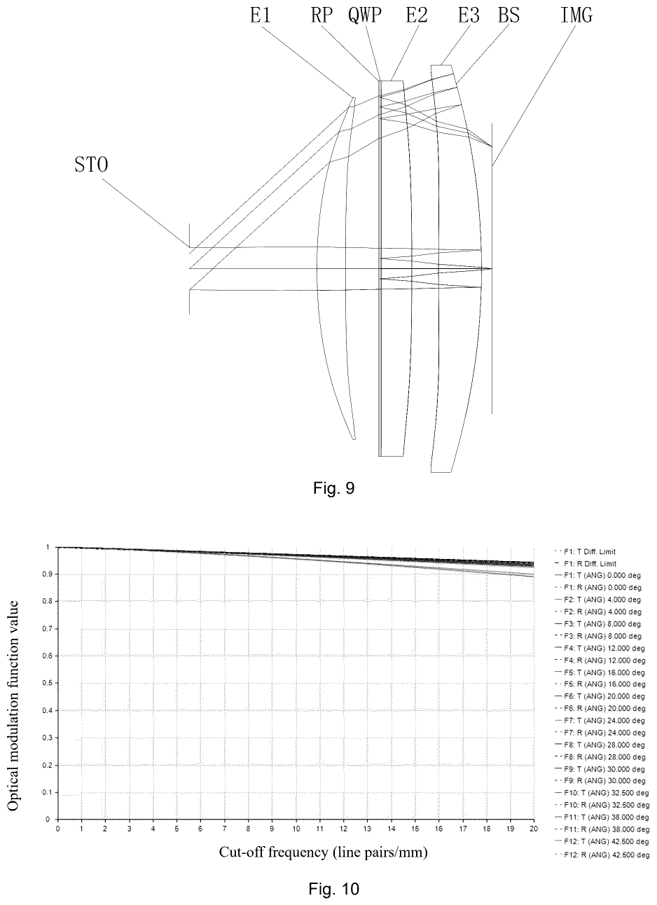

A visual system according to Embodiment 3 of the present application will be described below with reference to FIGS. 9 to 12.

In this example, the visual system also includes a first lens E1, a reflective polarizing element RP, a quarter-wave plate QWP, a second lens E2, a third lens E3, and a partially reflective element BS arranged in order from a first side to a second side along an optical axis. The first lens E1 has a positive refractive power, with a first side surface being convex and a second side surface being concave. The second lens E2 has a positive refractive power, with a first side surface being planar and a second side surface being convex. The third lens E3 has a positive refractive power, with a first side surface being convex and a second side surface being convex. The quarter-wave plate QWP is disposed on the first side surface of the second lens E2. The reflective polarizing element RP is disposed on a first side surface of the quarter-wave plate QWP. The partially reflective element BS is disposed on the second side surface of the third lens E3.

Table 7 shows basic parameters of the visual system according to this embodiment.

TABLE 7

| | | Surface | Radius of | Thickness/ | Refractive | Dispersion | Refraction/ | Cone |
|---|---|---|---|---|---|---|---|---|
| Surface | Element | type | curvature | distance | index | coefficient | reflection | coefficient |
| S0 | | Spherical | Infinite | D1 | | | Refraction | |
| S1 | Stop (STO) | Spherical | Infinite | 12.0000 | | | Refraction | |
| S2 | First lens (E1) | Aspherical | 47.0881 | 2.7025 | 1.644 | 23.98 | Refraction | −0.2124 |
| S3 | | Aspherical | 875.8852 | 3.1014 | | | Refraction | −99.0000 |
| S4 | Reflective polarizing | Spherical | Infinite | 0.1180 | 1.495 | 57.47 | Refraction | |
| | element (RP) | | | | | | | |
| S5 | Quarter-wave plate | Spherical | Infinite | 0.1340 | 1.495 | 57.47 | Refraction | |
| | (QWP) | | | | | | | |
| S6 | Second lens (E2) | Spherical | Infinite | 2.8843 | 1.548 | 56.30 | Refraction | |
| S7 | | Aspherical | −404.4616 | D2 | | | Refraction | −99.0000 |
| S8 | Third lens (E3) | Aspherical | 356.0161 | 4.0473 | 1.644 | 23.98 | Refraction | 98.8833 |
| S9 | Partially reflective | Aspherical | −67.3652 | −4.0473 | 1.644 | 23.98 | Reflection | 1.6548 |
| | element (BS) | | | | | | | |
| S10 | | Aspherical | 356.0161 | D3 | | | Refraction | 98.8833 |
| S11 | | Aspherical | −404.4616 | −2.8843 | 1.548 | 56.30 | Refraction | −99.0000 |
| S12 | | Spherical | Infinite | −0.1340 | 1.495 | 57.47 | Refraction | |
| S13 | Reflective polarizing | Spherical | Infinite | 0.1340 | 1.495 | 57.47 | Reflection | |
| | element (RP) | | | | | | | |
| S14 | Second lens (E2) | Spherical | Infinite | 2.8843 | 1.548 | 56.30 | Refraction | |
| S15 | | Aspherical | −404.4616 | D4 | | | Refraction | −99.0000 |
| S16 | Third lens (E3) | Aspherical | 356.0161 | 4.0473 | 1.644 | 23.98 | Refraction | 98.8833 |
| S17 | | Aspherical | −67.3652 | D5 | | | Refraction | 1.6548 |
| S18 | Image plane (IMG) | Spherical | Infinite | 0.0000 | | | Refraction | |

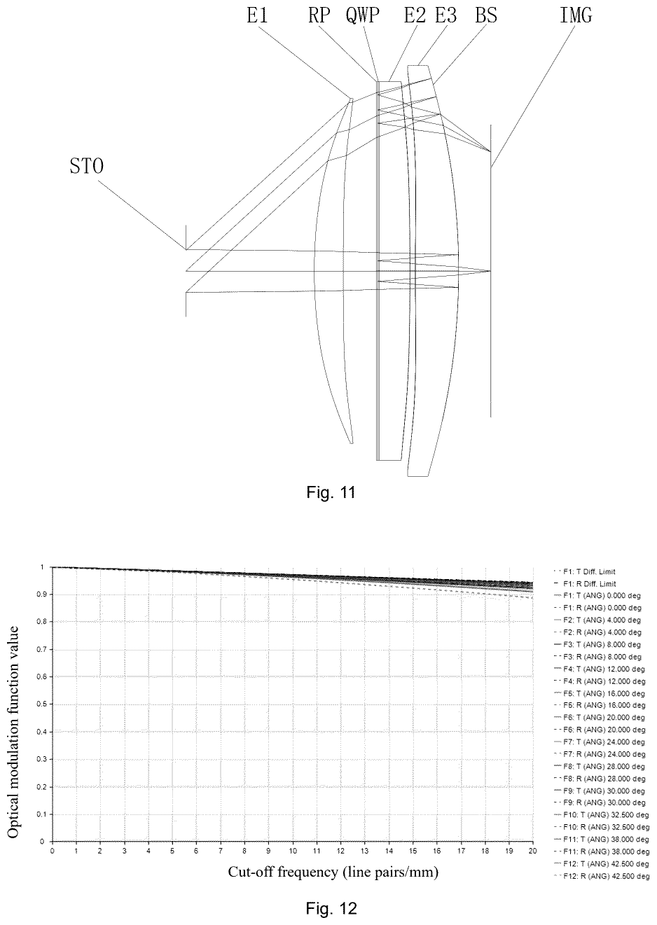

In this example, a stop STO may be provided on the first side of the visual system, and a display/image plane IMG may be provided on the second side of the visual system. The respective distances, along the optical axis, of the first lens E1, the reflective polarizing element RP, the quarter-wave plate QWP, and the second lens E2 to the display/image plane IMG are relatively fixed. The third lens E3 and the partially reflective element BS may be moved along the optical axis to approach or move away from the display/image plane IMG. During this process, the visual system can achieve zooming within the range of −5D to +2D. FIG. 9 shows a schematic structural diagram of the visual system when the third lens E3 and the partially reflective element BS are moved along the optical axis to a position closest to the display/image plane IMG. In this case, the visual system is in a +2D state. FIG. 11 shows a schematic structural diagram of the visual system when the third lens E3 and the partially reflective element BS are moved along the optical axis to a position farthest from the display/image plane IMG. In this case, the visual system is in a −5D state.

The corresponding values of parameters D1 to D5 in Table 7 for the visual system according to this embodiment in the +2D state shown in FIG. 9 and the −5D state shown in FIG. 11 are each shown in Table 8 below.

TABLE 8

| | D1 | D2 | D3 | D4 | D5 |
|---|---|---|---|---|---|
| +2D state | 500.0000 | 2.5168 | −2.5168 | 2.5168 | 1.0059 |
| −5D state | −200.0000 | 0.5000 | −0.5000 | 0.5000 | 3.0227 |

In this embodiment, the first side surface S2 and the second side surface S3 of the first lens E1, the second side surface S15 of the second lens E2, and the first side surface S16 and the second side surface S17 of the third lens E3 are all aspherical surfaces. The surface profile of each aspherical surface can be calculated using formula (1) in Embodiment 1. Higher-order coefficients A₄, A₆, A₈, A₁₀, A₁₂, A₁₄, A₁₆, A₁₈, and A₂₀ that can be used for each of the aspherical lens surfaces S2-S3 and S15-S17 in this embodiment are given in Table 9 below.

TABLE 9

| | surface | | | | |
|---|---|---|---|---|---|
| Coefficient | S2 | S3 | S15 | S16 | S17 |
| A4 | 1.4038E−05 | 1.8767E−05 | −6.5116E−06 | −1.5610E−05 | −1.8373E−06 |
| A6 | −1.6708E−08 | −4.1959E−09 | −1.3323E−08 | 1.1594E−08 | 5.3844E−09 |
| A8 | −6.7526E−12 | −7.7654E−11 | 8.2942E−11 | 8.6405E−12 | −4.2091E−12 |
| A10 | −5.0914E−14 | −5.2974E−14 | −6.5459E−14 | 4.6664E−15 | 1.4005E−14 |
| A12 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 |

FIG. 10 shows an MTF curve of the visual system according to this embodiment when it is in the +2D state shown in FIG. 9, and FIG. 12 shows an MTF curve of the visual system according to this embodiment when it is in the −5D state shown in FIG. 11. It can be seen from FIGS. 10 and 12 that the visual system given in this embodiment can achieve good imaging quality in both the +2D and −5D focal length states.

### Embodiment 4

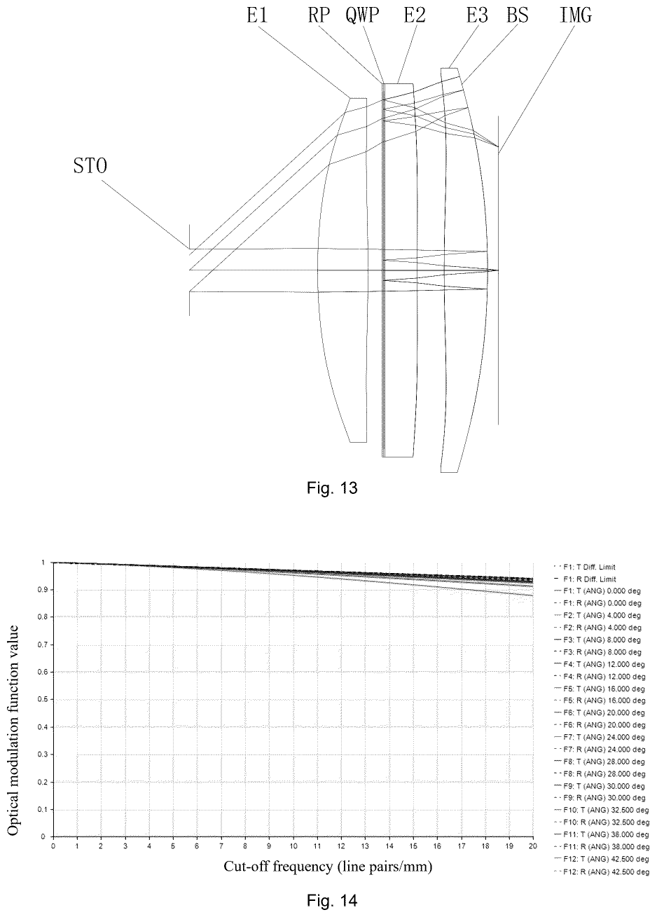

A visual system according to Embodiment 4 of the present application will be described below with reference to FIGS. 13 to 16.

In this example, the visual system also includes a first lens E1, a reflective polarizing element RP, a quarter-wave plate QWP, a second lens E2, a third lens E3, and a partially reflective element BS arranged in order from a first side to a second side along an optical axis. The first lens E1 has a positive refractive power, with a first side surface being convex and a second side surface being convex. The second lens E2 has a negative refractive power, with a first side surface being planar and a second side surface being concave. The third lens E3 has a positive refractive power, with a first side surface being convex and a second side surface being convex. The quarter-wave plate QWP is disposed on the first side surface of the second lens E2. The reflective polarizing element RP is disposed on a first side surface of the quarter-wave plate QWP. The partially reflective element BS is disposed on the second side surface of the third lens E3.

Table 10 shows basic parameters of the visual system according to this embodiment.

TABLE 10

| | | Surface | Radius of | Thickness/ | Refractive | Dispersion | Refraction/ | Cone |
|---|---|---|---|---|---|---|---|---|
| Surface | Element | type | curvature | distance | index | coefficient | reflection | coefficient |
| S0 | | Spherical | Infinite | D1 | | | Refraction | |
| S1 | Stop (STO) | Spherical | Infinite | 12.0000 | | | Refraction | |
| S2 | First lens (E1) | Aspherical | 51.1878 | 4.7056 | 1.548 | 56.30 | Refraction | −0.8929 |
| S3 | | Aspherical | −147.8388 | 1.3075 | | | Refraction | 15.4025 |
| S4 | Reflective polarizing | Spherical | Infinite | 0.1180 | 1.495 | 57.47 | Refraction | |
| | element (RP) | | | | | | | |
| S5 | Quarter-wave plate | Spherical | Infinite | 0.1340 | 1.495 | 57.47 | Refraction | |
| | (QWP) | | | | | | | |
| S6 | Second lens (E2) | Spherical | Infinite | 3.0429 | 1.644 | 23.98 | Refraction | |
| S7 | | Aspherical | 919.1882 | D2 | | | Refraction | 99.0000 |
| S8 | Third lens (E3) | Aspherical | 145.7352 | 4.0634 | 1.548 | 56.30 | Refraction | −30.9370 |
| S9 | Partially reflective | Aspherical | −67.4540 | −4.0634 | 1.548 | 56.30 | Reflection | 1.7579 |
| | element (BS) | | | | | | | |
| S10 | | Aspherical | 145.7352 | D3 | | | Refraction | −30.9370 |
| S11 | | Aspherical | 919.1882 | −3.0429 | 1.644 | 23.98 | Refraction | 99.0000 |
| S12 | | Spherical | Infinite | −0.1340 | 1.495 | 57.47 | Refraction | |
| S13 | Reflective polarizing | Spherical | Infinite | 0.1340 | 1.495 | 57.47 | Reflection | |
| | element (RP) | | | | | | | |
| S14 | Second lens (E2) | Spherical | Infinite | 3.0429 | 1.644 | 23.98 | Refraction | |
| S15 | | Aspherical | 919.1882 | D4 | | | Refraction | 99.0000 |
| S16 | Third lens (E3) | Aspherical | 145.7352 | 4.0634 | 1.548 | 56.30 | Refraction | −30.9370 |
| S17 | | Aspherical | −67.4540 | D5 | | | Refraction | 1.7579 |
| S18 | Image plane (IMG) | Spherical | Infinite | 0.0000 | | | Refraction | |

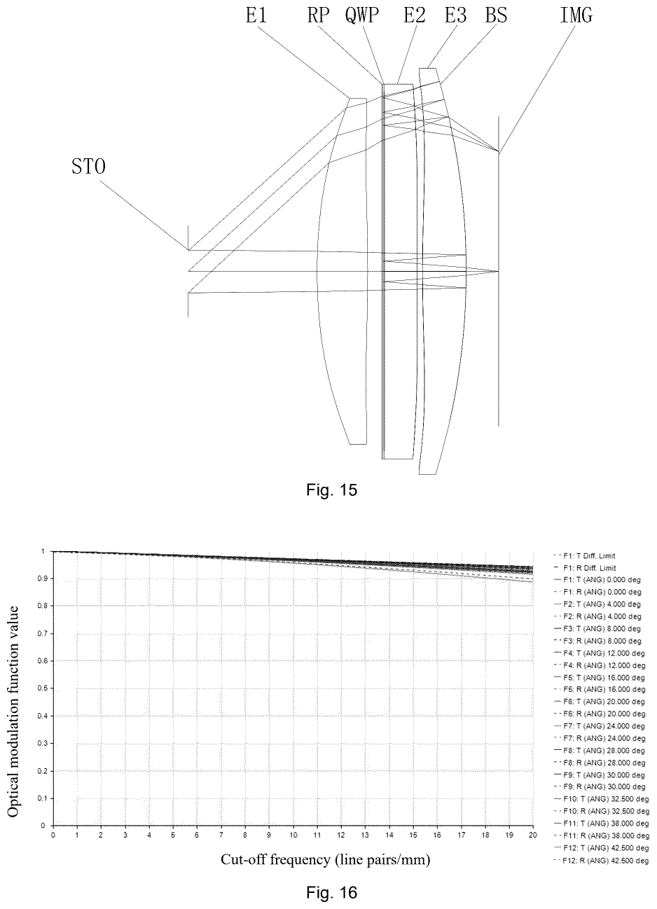

In this example, a stop STO may be provided on the first side of the visual system, and a display/image plane IMG may be provided on the second side of the visual system. The respective distances, along the optical axis, of the first lens E1, the reflective polarizing element RP, the quarter-wave plate QWP, and the second lens E2 to the display/image plane IMG are relatively fixed. The third lens E3 and the partially reflective element BS may be moved along the optical axis to approach or move away from the display/image plane IMG. During this process, the visual system can achieve zooming within the range of −5D to +2D. FIG. 13 shows a schematic structural diagram of the visual system when the third lens E3 and the partially reflective element BS are moved along the optical axis to a position closest to the display/image plane IMG. In this case, the visual system is in a +2D state. FIG. 15 shows a schematic structural diagram of the visual system when the third lens E3 and the partially reflective element BS are moved along the optical axis to a position farthest from the display/image plane IMG. In this case, the visual system is in a −5D state.

The corresponding values of parameters D1 to D5 in Table 10 for the visual system according to this embodiment in the +2D state shown in FIG. 13 and the −5D state shown in FIG. 15 are each shown in Table 11 below.

TABLE 11

| | D1 | D2 | D3 | D4 | D5 |
|---|---|---|---|---|---|
| +2D state | 500.0000 | 2.5172 | −2.5172 | 2.5172 | 1.0072 |
| −5D state | −200.0000 | 0.5000 | −0.5000 | 0.5000 | 3.0244 |

In this embodiment, the first side surface S2 and the second side surface S3 of the first lens E1, the second side surface S15 of the second lens E2, and the first side surface S16 and the second side surface S17 of the third lens E3 are all aspherical surfaces. The surface profile of each aspherical surface can be calculated using formula (1) in Embodiment 1. Higher-order coefficients A₄, A₆, A₈, A₁₀, A₁₂, A₁₄, A₁₆, A₁₈, and A₂₀ that can be used for each of the aspherical lens surfaces S2-S3 and S15-S17 in this embodiment are given in Table 12 below.

TABLE 12

| | surface | | | | |
|---|---|---|---|---|---|
| Coefficient | S2 | S3 | S15 | S16 | S17 |
| A4 | 1.3331E−05 | 1.9083E−05 | −6.8529E−06 | −1.6021E−05 | −1.8602E−06 |
| A6 | −1.7956E−08 | −3.2471E−09 | −1.4780E−08 | 1.0149E−08 | 5.1156E−09 |
| A8 | −1.0774E−11 | −7.4438E−11 | 8.2367E−11 | 5.1383E−12 | −4.4310E−12 |
| A10 | −2.9788E−14 | −6.7165E−14 | −7.6669E−14 | 4.5276E−15 | 1.1610E−14 |
| A12 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 |

FIG. 14 shows an MTF curve of the visual system according to this embodiment when it is in the +2D state shown in FIG. 13, and FIG. 16 shows an MTF curve of the visual system according to this embodiment when it is in the −5D state shown in FIG. 15. It can be seen from FIGS. 14 and 16 that the visual system given in this embodiment can achieve good imaging quality in both the +2D and −5D focal length states.

In summary, in Embodiments 1 to 4, the effective focal length fm of the visual system in the +2D state, the effective focal length fn of the visual system in the −5D state, the effective focal length f1 of the first lens, the effective focal length f2 of the second lens, the effective focal length f3 of the third lens, the entrance pupil diameter EPD of the visual system, the distance TDm on the optical axis from the first side surface of the first lens to the second side surface of the third lens in the +2D state of the visual system, the distance TDn on the optical axis from the first side surface of the first lens to the second side surface of the third lens in the −5D state of the visual system, the distance T23m on the optical axis from the second side surface of the second lens to the first side surface of the third lens in the +2D state of the visual system, the distance T23n on the optical axis from the second side surface of the second lens to the first side surface of the third lens in the −5D state of the visual system, the distance BFLm on the optical axis from the second side surface of the third lens to the display/image plane in the +2D state of the visual system, and the distance BFLn on the optical axis from the second side surface of the third lens to the display/image plane in the −5D state of the visual system, the distance ΔL by which the third lens moves along the optical axis when the visual system switches from the +2D state to the −5D state, and the amount of change Δf in the effective focal length of the system when the visual system switches from the +2D state to the −5D state are each shown in Table 13 below.

TABLE 13

| | Embodiment | | | |
|---|---|---|---|---|
| | Embodi- | Embodi- | Embodi- | Embodi- |
| Parameter | ment 1 | ment 2 | ment 3 | ment 4 |
| fm (mm) | 17.43 | 17.35 | 16.77 | 17.10 |
| fn (mm) | 16.26 | 16.09 | 15.56 | 15.96 |
| f1 (mm) | 70.64 | 115.75 | 77.22 | 69.98 |
| f2 (mm) | 890596.73 | 330.04 | 738.12 | −1428.15 |
| f3 (mm) | 90.15 | 108.26 | 88.34 | 84.72 |
| EPD (mm) | 4.00 | 8.00 | 4.00 | 4.00 |
| TDm (mm) | 16.60 | 14.32 | 15.50 | 15.89 |
| TDn (mm) | 14.57 | 12.06 | 13.49 | 13.87 |
| T23m (mm) | 2.52 | 3.07 | 2.52 | 2.52 |
| T23n (mm) | 0.50 | 0.81 | 0.50 | 0.50 |
| BFLm (mm) | 1.00 | 1.04 | 1.01 | 1.01 |
| BFLn (mm) | 3.02 | 3.30 | 3.02 | 3.02 |
| ΔL (mm) | 2.02 | 2.26 | 2.02 | 2.02 |
| Δf (mm) | 1.17 | 1.26 | 1.22 | 1.14 |

In addition, Embodiments 1 to 4 satisfy the conditions shown in Table 14, respectively.

TABLE 14

| | Embodiment | | | |
|---|---|---|---|---|
| | Embodi- | Embodi- | Embodi- | Embodi- |
| Conditional Expression | ment 1 | ment 2 | ment 3 | ment 4 |
| f3/fm | 5.17 | 6.24 | 5.27 | 4.95 |
| CT3/Δf | 3.46 | 3.20 | 3.32 | 3.56 |
| R1/(fm + fn) | 1.49 | 1.92 | 1.46 | 1.55 |
| (CT1 + CT2)/ΔL | 4.30 | 2.74 | 2.77 | 3.84 |
| f1/TDm | 4.26 | 8.08 | 4.98 | 4.40 |
| (T23m + T23n)/T12 | 2.30 | 3.73 | 0.90 | 1.93 |
| (R6/R5) × Δf (mm) | −0.48 | −0.17 | −0.23 | −0.53 |
| TDn/(CT2 + CTR + | 4.48 | 3.71 | 4.30 | 4.21 |
| CTQ) | | | | |
| fm/T23m | 6.91 | 5.65 | 6.67 | 6.79 |
| BFLn/T23n | 6.04 | 4.06 | 6.05 | 6.05 |
| Δf/BFLm | 1.17 | 1.21 | 1.21 | 1.13 |
| TDn/EPD | 3.64 | 1.51 | 3.37 | 3.47 |
| f3/(R5 + R6) | 0.91 | 0.26 | 0.31 | 1.08 |
| R6/CT3 | −17.06 | −16.72 | −16.64 | −16.60 |
| TDn/ΔL | 7.21 | 5.34 | 6.69 | 6.88 |

The above description is only the preferred embodiments of the present application and the explanation of the applied technical principle. It should be understood by those skilled in the art that the scope of protection involved in the present application is not limited to technical solutions formed by specific combinations of the above technical features, and at the same time, should also cover other technical solutions formed by any combination of the above technical features or equivalent features thereof without departing from the concept of the present application. For example, the above features are replaced with (but not limited to) the technical features with similar functions disclosed in the present application to form technical solutions.

What is claimed is:

1. A visual system, comprising, in order from a first side to a second side along an optical axis:
a first lens having a positive refractive power, with a first side surface being convex;
a reflective polarizing element;
a quarter-wave plate;
a second lens having a positive refractive power or a negative refractive power, with a first side surface being planar;
a third lens having a positive refractive power, with a first side surface being convex and a second side surface being convex; and
a partially reflective element,
wherein the third lens is configured to be able to move along the optical axis to approach or move away from a display located on the second side, so that the visual system switches between a first state and a second state; and
the visual system satisfies:
4.95≤f3/fm≤6.24; and
3.20≤CT3/Δf≤3.56;
where f3 is an effective focal length of the third lens, fm is an effective focal length of the visual system in the first state, CT3 is a center thickness of the third lens on the optical axis, and Δf is an amount of change in the effective focal length of the visual system when switching from the first state to the second state.

2. The visual system according to claim 1, wherein a radius of curvature R1 of the first side surface of the first lens, and the effective focal length fm of the visual system in the first state and an effective focal length fn of the visual system in the second state satisfy:
1.45<R1/(fm+fn)<1.95.

3. The visual system according to claim 1, wherein a center thickness CT1 of the first lens on the optical axis, a center thickness CT2 of the second lens on the optical axis, and a distance ΔL by which the third lens moves along the optical axis in a process of the visual system switching from the first state to the second state satisfy:
2.74≤(CT1+CT2)/ΔL≤4.30.

4. The visual system according to claim 1, wherein an effective focal length f1 of the first lens and a distance TDm on the optical axis from the first side surface of the first lens to the second side surface of the third lens in the first state of the visual system satisfy:
4.25<f1/TDm<8.1.

5. The visual system according to claim 1, wherein a distance T23m on the optical axis from the second side surface of the second lens to the first side surface of the third lens in the first state of the visual system, and a distance T23n on the optical axis from the second side surface of the second lens to the first side surface of the third lens in the second state of the visual system, and a distance T12 on the optical axis from the second side surface of the first lens to the first side surface of the second lens satisfy:
0.90≤(T23m+T23n)/T12≤3.73.

6. The visual system according to claim 1, wherein a radius of curvature R6 of the second side surface of the third lens and a radius of curvature R5 of the first side surface of the third lens, and the amount of change Δf in the effective focal length of the visual system when switching from the first state to the second state satisfy:
−0.55 mm<(R6/R5)×Δf<−0.15 mm.

7. The visual system according to claim 1, wherein a distance TDn on the optical axis from the first side surface of the first lens to the second side surface of the third lens in the second state of the visual system, a center thickness CT2 of the second lens on the optical axis, a center thickness CTR of the reflective polarizing element on the optical axis, and a center thickness CTQ of the quarter-wave plate on the optical axis satisfy:
3.7<TDn/(CT2+CTR+CTQ)<4.5.

8. The visual system according to claim 1, wherein the effective focal length fm of the visual system in the first state, and a distance T23m on the optical axis from the second side surface of the second lens to the first side surface of the third lens in the first state of the visual system satisfy:
5.65≤fm/T23m≤6.91.

9. The visual system according to claim 1, wherein a distance BFLn on the optical axis from the second side surface of the third lens to the display in the second state of the visual system, and a distance T23n on the optical axis from the second side surface of the second lens to the first side surface of the third lens in the second state of the visual system satisfy:
4.06≤BFLn/T23n≤6.05.

10. The visual system according to claim 1, wherein the amount of change Δf in the effective focal length of the visual system when switching from the first state to the second state, and a distance BFLm on the optical axis from the second side surface of the third lens to the display in the first state of the visual system satisfy:
1.1<Δf/BFLm<1.25.

11. The visual system according to claim 1, wherein a distance TDn on the optical axis from the first side surface of the first lens to the second side surface of the third lens in the second state of the visual system, and an entrance pupil diameter EPD of the visual system satisfy:
1.5<TDn/EPD<3.65.

12. The visual system according to claim 1, wherein the effective focal length f3 of the third lens, and a radius of curvature R5 of the first side surface of the third lens and a radius of curvature R6 of the second side surface of the third lens satisfy:
0.25<f3/(R5+R6)<1.1.

13. The visual system according to claim 1, wherein a radius of curvature R6 of the second side surface of the third lens and the center thickness CT3 of the third lens on the optical axis satisfy:
−17.06≤R6/CT3≤−16.60.

14. The visual system according to claim 1, wherein a distance TDn on the optical axis from the first side surface of the first lens to the second side surface of the third lens in the second state of the visual system, and a distance ΔL by which the third lens moves along the optical axis in a process of the visual system switching from the first state to the second state satisfy:
5.3<TDn/ΔL<7.25.
